(19) United States
(12) Patent Application Publication
(10) Pub. No.: US 2026/0131767 A1
(43) Pub. Date: May 14, 2026

(54) PARKING BRAKE AND ELECTRIC MACHINE COMPRISING SUCH A BRAKE

(71) Applicant: AMPERE S.A.S., Boulogne Billancourt (FR)

(72) Inventor: Eric DUMAS, Guyancourt (FR)

(73) Assignee: AMPERE S.A.S., Boulogne Billancourt (FR)

(21) Appl. No.: 19/118,120

(22) PCT Filed: Oct. 5, 2023
(86) PCT No.: PCT/EP2023/077646

§ 371 Date: Apr. 23, 2025

(30) Foreign Application Priority Data
Oct. 6, 2022 (FR) FR2210244

(51) Int. Cl. B60T 1/00; B60T 13/74; F16D 63/00; F16D 65/16; F16D 121/18; H02K 7/102

(52) U.S. Cl. CPC B60T 1/005; B60T 13/746; F16D 63/006; F16D 65/16; H02K 7/102; F16D 2121/18

(57) ABSTRACT

A parking brake device is suitable for being installed in a casing of an electric machine that houses a rotary shaft and at least one rolling bearing for guiding the rotary shaft. The parking brake device includes an annular support suitable for being inserted between the rolling bearing and the casing, an annular sliding gear which is mounted so as to slide on the support between two end positions, which is locked against rotation on the support, and which has dog clutches suitable for engaging a notched wheel coupled to the rotary shaft, and an actuator suitable for moving the sliding gear between its two end positions.

### TECHNICAL FIELD OF THE INVENTION

The present invention relates in general to the braking of motor vehicles.

It relates more particularly to a device that has a parking brake function.

It also relates to an electric machine equipped with such a device and to a motor vehicle comprising such an electric machine.

### PRIOR ART

Various types of parking brake are known.

For example hand brakes, which comprise a handle able to pull a metal cable connected to a brake caliper able to immobilize the rear wheels of the vehicle, are known.

Electric parking brakes comprise an actuator once again able to actuate cables connected to brake calipers are also known.

While this second system saves space compared with the first, it is still bulky and also costly.

A device arranged differently and usable on electric vehicles is therefore known from document DE102017217829. In that document, the braking device comprises a pawl mechanism able to lock onto a notched wheel fixed to the shaft of the electric motor of the vehicle. Thus, this device makes it possible to immobilize, in terms of rotation, the shaft of the electric motor and, therefore, the wheels of the vehicle.

However, this device is still bulky. It is also unable to reduce the noise of the electric motor.

### DESCRIPTION OF THE INVENTION

In order to overcome the aforementioned disadvantages of the prior art, the present invention proposes siting the parking brake as close as possible to the motor.

More particularly, what is proposed according to the invention is a parking brake device suitable for being installed in a casing of an electric machine which casing houses a rotary shaft and at least one rolling bearing for guiding said rotary shaft. According to the invention, this parking brake device comprises:
an annular support suitable for being inserted between said rolling bearing and said casing,
an annular sliding gear which is mounted on the support with the ability to slide between two extreme positions, which is immobilized against rotation on said support, and which has at least one relief (typically one or more dog(s)) able to engage in a dog-clutch manner with a notched wheel coupled to said rotary shaft, and
an actuator suitable for moving the sliding gear between its two extreme positions.

The annular nature of the support and of the sliding gear allows these elements to be positioned around the rotary shaft of the electric machine. Thus, by virtue of the invention, the device can be positioned in the casing of the electric machine, as close as possible to the rotor, in a space that hitherto was often left unoccupied. It therefore proves to be not very bulky and can be installed in a space that is protected and lubricated, thereby ensuring that it operates correctly over the long term and for a lower cost.

The advantage of positioning the support between the casing and the rolling bearing is that this support is therefore able to reduce the running noise. Specifically, if made from a suitable material, it can have a stiffness greater than that which the casing might have, and this will reduce vibrations and therefore noise.

Typically, when this support is made from gray cast iron, it is able to damp acyclic behaviors of the rotary shaft and ensure good lubrication around the rolling bearing when the latter is rotating at a very high speed and becomes “levitating”.

This support, when made from a suitable material, can moreover exhibit a coefficient of expansion that is closer to that of the rolling bearing than the casing, so that the clearance around the rolling bearing will be less sensitive to thermal variations, thereby further reducing noise.

By reducing vibration, this support will also make it possible to guarantee the electric machine as a whole a longer lifespan.

Finally, it will be noted that the benefit of positioning this parking brake device as close as possible to the rotor of the electric machine, rather than close to the wheels of the vehicle, is that the braking torque that will need to be provided in order to immobilize the vehicle will be lower than that which would be needed were it positioned at the wheels. Specifically, this braking torque will be divided by the speed-reduction ratio between the rotary shaft of the motor and the wheels. It is therefore possible to use a braking device of smaller dimensions.

Further advantageous and nonlimiting features of the device according to the invention, considered individually or in any technically possible combination(s), are as follows:
the support is formed of a single one-piece part;
the support is produced from cast iron;
the support delimits an internal face of which a part that is a cylinder of revolution accommodates said rolling bearing;
the support delimits an external face of which a part that is a cylinder of revolution is suitable for being installed in an opening in the casing;
the support and the sliding gear have splines that collaborate with each other;
the splines extend on an external face of the support and on an internal face of the sliding gear;
there is provided, between the actuator and the sliding gear, an elastically deformable part suitable for allowing the actuator to move when the sliding gear is immobilized by the notched wheel.

The invention also proposes an electric machine comprising:
a casing,
a rotor housed in the casing,
a rotary shaft which is fixed to the rotor, which is mounted in the casing with the ability to pivot by means of at least one rolling bearing, and which bears a notched wheel, and
a parking brake device as mentioned hereinabove of which the sliding gear engages the notched wheel, in the manner of a dog clutch, when said sliding gear is in just one of its two extreme positions.

As a preference, the notched wheel is shrink-fitted onto said rotary shaft.

The invention also proposes a motor vehicle comprising a chassis, wheels, and an electric machine as mentioned hereinabove, of which the rotary shaft is constantly coupled to at least some of said wheels.

Of course, the various features, variants and embodiments of the invention may be combined with one another in various combinations provided that they are not mutually incompatible or mutually exclusive.

### DETAILED DESCRIPTION OF THE INVENTION

The description which will follow with reference to the attached drawings given by way of nonlimiting examples will make it easy to understand what the invention is and how it may be embodied.

In the attached figures:

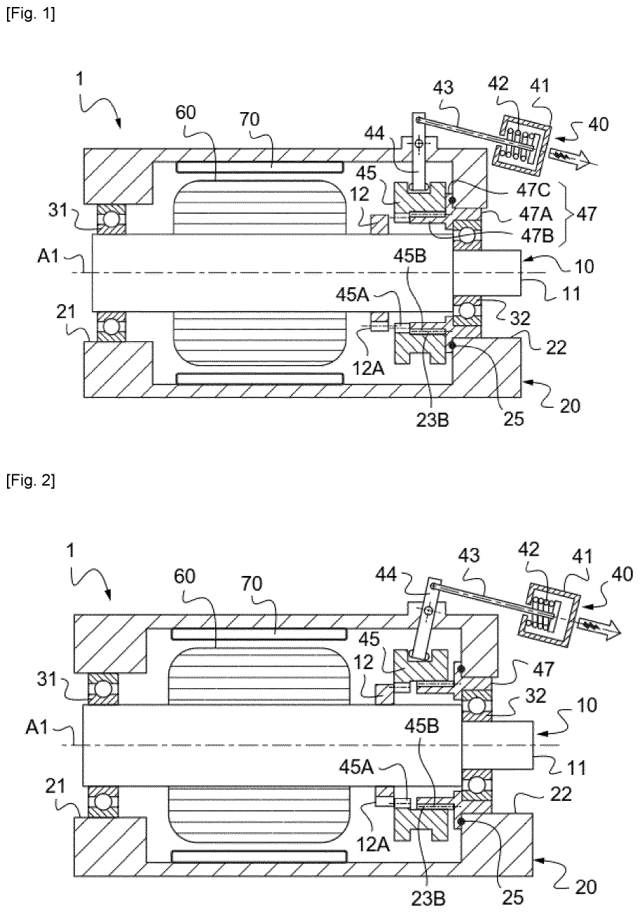

FIG. 1 is a schematic view in cross section of an electric machine according to the invention, comprising a parking brake device illustrated in an inactive position;

FIG. 2 is a view similar to that of FIG. 1, in which the parking brake device is illustrated in an intermediate position;

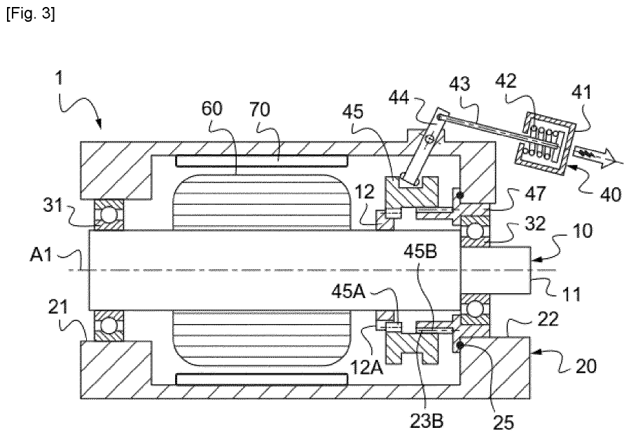

FIG. 3 is a view similar to that of FIG. 1, in which the parking brake device is illustrated in an active position.

FIG. 1 depicts an electric machine 1 of a motor vehicle.

This motor vehicle may be of any type.

It is, for example, an electric or hybrid motor car comprising a chassis and wheels, of which the electric machine serves as a traction motor to drive the driven wheels. In such an eventuality, the electric machine is preferably coupled to the driven wheels via a speed reducer and a differential. This coupling is continuous in the sense that it is not possible to uncouple the driven wheels from the electric machine.

As shown in FIG. 1, the electric machine 1 conventionally comprises an external casing 20 which is produced in several parts that are assembled to delimit a chamber housing a rotor 60 and an annular stator 70.

This may be an electric machine of any type, with axial or radial flux, a wound rotor, or otherwise, etc.

Conventionally, the stator 70 is fixed to the casing while the rotor 60 is intended to pivot in the stator 70.

The rotor 60 has a central opening via which it is fixedly mounted on a rotary shaft 10 which therefore forms the output shaft of the electric machine 1.

Conventionally, this rotary shaft 10 is mounted in the casing 20 such as to be able to rotate with respect to the latter about an axis of rotation A1.

For that purpose it is equipped with two rolling bearings 31, 32, in this instance ballbearings, the inner races of which are shrink-fitted onto the rotary shaft 10 and the outer races of which are placed in coaxial openings 21, 22 made in the casing 20 and acting as bearing housings. Thus, the rotary shaft 10 is guided in rotation about its axis of rotation A1.

It will be noted here that the rotary shaft 10 has, on one side (the right-hand side in the figures), a reduction in cross section 11 allowing it to be engaged in a first of the rolling bearings 32 and that it is devoid of such a reduction in cross section on the opposite side, because the second rolling bearing 31 has a diameter greater than that of the first.

It will also be noted that the two openings 21, 22 housing the rolling bearings 31, 32 have the same diameters. Therefore only the second rolling bearing 31 has an outer race that is directly shrink-fitted into the opening 21 of the casing 20.

According to the invention, the electric machine 1 is effectively equipped with a parking brake device 40 on the same side as the first rolling bearing 32.

This device is designed to act directly on the rotary shaft 10 of the electric machine 1 in order to brake the vehicle when the latter is parked.

In an electric or hybrid vehicle as defined above, the electric machine actually always remains coupled to the driven wheels of the vehicle because neither clutch nor gearbox is provided between the electric machine 1 and the driven wheels. By contrast, what is provided is a simple speed reducer (typically a constant-mesh single-ratio device). As a result, immobilizing the rotary shaft 10 of the electric machine 1 enables the driven wheels to be immobilized thus providing a high-performance braking when parked.

In this regard, it may be noted that if a torque is applied to the wheels, the torque experienced at the rotary shaft 10 will be reduced by the speed reducer so that it will be less demanding to brake the vehicle at the rotary shaft 10 than at the wheels.

Here, the parking brake device 40 is positioned around the rotary shaft 10. The part that mechanically provides the braking is situated between the rotor 60 and the first of the rolling bearings 32, inside the casing 20. It is therefore particularly lacking in bulkiness.

In order to achieve the desired braking, the device comprises an annular support 47 fixed to the casing 20, and an annular sliding gear 45 mounted on the support 47 with a single degree of freedom, namely mobility in sliding between two extreme positions:
an inactive position (FIG. 1), and
an activated position (FIG. 3) in which the sliding gear 45 is coupled in a dog-clutch manner to a notched wheel 12 which is fixed to the rotary shaft 10.

In the embodiment illustrated in the figures, the notched wheel 12 is the shape of an annulus, with two planar main faces, an internal face that is a cylinder of revolution about the axis of rotation A1, and an external face that has at least one relief (in this instance, this external face has a number of dogs).

This notched wheel 12 is shrink-fitted onto the rotary shaft 10, near the rotor 60 (between the latter and the first rolling bearing 32).

The dogs have identical shapes and are regularly distributed over the periphery of the notched wheel 12. They form, for example, crenellations of which the lateral faces extend radially with respect to the axis of rotation A1. They are thus “profiled” in the sense that they have orthogonal sections that are uniform along the axis of rotation A1.

The support 47 on which the sliding gear 45 slides in order to engage this notched wheel 12 in the manner of a dog clutch, is installed in the opening 22 of the casing 20 such that it is inserted between the edge of this opening 22 and the outer race of the first rolling bearing 32.

It is a one-piece part produced by casting. It is preferably produced in gray cast iron, which gives its lubricating and damping properties.

This support 47 therefore forms a high-stiffness interface between the first rolling bearing 32 and the casing 20, making it possible to reduce the noise generated by the rotation of the rotary shaft 10.

Specifically, it is produced in a material that has a stiffness higher than that of the material of the casing 20. Further, because of its presence, the opening 22 in the casing 20 has a diameter greater than it would have had to have in the absence of the support 47, which means that the casing 20 itself has a stiffness greater than it would have had in the absence of the support 47. Thus, the rotary shaft 10 is better guided, better damped, and vibrates less, all of which reduces stress and noise.

As shown in FIG. 1, this support 47 has a first end part 47A inserted between the rolling bearing 32 and the casing 20, a second, opposite, end part 47B on which the sliding gear 45 slides, and an intermediate ring-flange 47C which extends between these two parts and presses against the internal face of the casing 20 in order to immobilize the support 47 in the opening 22.

The first end part 47A has the form of a ring, with an internal face shrink-fitted onto the outer race of the first rolling bearing 32, and an external face shrink-fitted into the opening 22. These two faces are cylinders of revolution about the axis of rotation A1.

The intermediate ring-flange 47C is in the shape of a washer, with two planar main faces orthogonal to the axis of rotation A1, one of which presses against the internal face of the casing 20.

It has inside and outside diameters that are respectively smaller and larger than those of the two end parts 47A, 47B. It thus forms an inward projection with respect to the internal faces of these two end parts, which projection presses against the outer race of the first rolling bearing 32 in order to immobilize same laterally. It also forms an outward projection with respect to the external faces of these two end parts, which projection presses against the internal face of the casing 20. In order to maintain this pressure, screws for fixing the support 47 in the casing 20 are provided here.

The second end part 47B has the form of a ring, with an external face of a particular shape in order to guide the translational movement of the sliding gear 45 along the axis of rotation A1 and immobilize this sliding gear in terms of rotation about this axis.

For that purpose, this external face forms profiled splines which collaborate with splines of corresponding shape, in negative, borne by the sliding gear 45.

This sliding gear 45 which, it will be recalled, also has an annular shape, therefore has splines on its interior face.

Here, these splines extend over just part of the length of this interior face. Specifically, one of the ends of this external face, the one facing toward the notched wheel 12, bears at least one projecting relief. In practice, it bears several identical ones that form dogs suitable for collaborating with those of the notched wheel 12. These dogs for that purpose have shapes that complement those of the notched wheel 12.

Thus, the sliding gear 45 can slide from its inactive position (FIG. 1), in which the dogs of the sliding gear are distant from those of the notched wheel 12 so as not to collaborate therewith, into its activated position (FIG. 3) in which the dogs collaborate with one another.

During this sliding, the sliding gear 45 passes via an intermediate position depicted in FIG. 2, in which the dogs of the sliding gear 45 engage in those of the notched wheel 12. This engagement requires for the rotary shaft 10 to be in a precise angular position about the axis of rotation A1 with respect to the sliding gear 45, something that is achieved without difficulty when the rotor 60 is controllable in terms of angular position. If not, dog-coupling will be able to be effected mechanically, as soon as the dogs of the notched wheel 12 come into alignment with the spaces provided between the dogs of the sliding gear 45.

In order to slide the sliding gear 45 between its inactive and activated extreme positions, an actuator 41 is provided.

It is possible to use any type of actuator, for example an electric servo motor, a mobile-magnet electromagnetic system, etc.

This actuator comprises a support fixed to the casing 20 and a sliding arm.

Here, this mobile arm bears a cage which is therefore translationally mobile. This cage is intended to apply a pulling or pushing force to a link rod 43 one end of which is articulated to an arm 44 suitable for causing the sliding gear to slide. In this particular instance, this arm 44 is pivot-mounted on the casing 20 and has one end projecting toward the inside of the casing 20, and which extends into a peripheral groove cut into the external face of the sliding gear 45, and one end projecting toward the outside of the casing, and on which the link rod 43 is articulated.

Thus, the pushing or pulling movement applied to the link rod 43 is able to force the arm 44 to pivot in one direction or the other, about an axis orthogonal to the axis of rotation A1, in order to cause the sliding gear 45 to slide between its two extreme positions.

In instances in which the rotor 60 is controllable in terms of angular position, provision could be made for the actuator 41 and the link rod 43 to be articulated to one another via a simple pivot connection.

However, as a safety measure, it is preferable to provide elastic means of connection between the actuator 41 and the link rod 43, so that if the sliding gear 45 is immobilized by the notched wheel 12 (as a result of their respective dogs not being correctly positioned relative to one another), these elastic means of connection allow the actuator to cause the cage to slide without damage and without forcing.

In this instance, these elastic connection means comprise a spring which is housed in the cage and sandwiched between one of the internal faces of this cage and a disk fixed to the end of the link rod 43.

At this stage, it may be noted that, conventionally, a dielectric lubricant is used to lubricate the rolling bearings 31, 32. This lubricant will naturally provide lubrication for the junction between the sliding gear 45 and its support 47, which will guarantee the parking brake device 40 correct operation and an extended lifespan.

It will also be noted that when the vehicle is stationary on an incline and the parking brake device 40 is activated, it may prove difficult to move this device into the inactive position because of the forces exerted on it.

Therefore, to make the sliding gear 45 easier to move, the electric machine 1 may be operated in such a way as to rotate the rotary shaft 10 through a small travel (of the order of 1 degree) and over a fairly short space of time during which the stresses applied to the device will be low.

More generally, it is possible, prior to each deactivation of the parking brake device 40, to cause the rotary shaft 10 to pivot in one direction then the other, in order to ensure that the sliding gear can shortly slide without difficulty on its support 47.

The present invention is not in any way restricted to the embodiment described and depicted but may be varied by a person skilled in the art in any way that remains in accordance with the invention.

1-10. (canceled)

11. A parking brake device for being installed in a casing of an electric machine which houses a rotary shaft and at least one rolling bearing for guiding said rotary shaft, the parking brake device comprising:
an annular support configured to be inserted between said rolling bearing and said casing (20);
an annular sliding gear which is mounted on the support and configured to slide between two extreme positions, which is immobilized against rotation on said support, and which has at least one relief configured to engage in a dog-clutch manner with a notched wheel coupled to said rotary shaft; and
an actuator configured to move the sliding gear between the two extreme positions.

12. The parking brake device as claimed in claim 11, wherein the support is formed of a single one-piece part.

13. The parking brake device as claimed in claim 11, wherein the support is at least partially produced from cast iron.

14. The parking brake device as claimed in claim 11, wherein the support delimits an internal face of which a part that is a cylinder of revolution accommodates said rolling bearing, and an external face of which a part that is a cylinder of revolution is configured to be installed in an opening in the casing.

15. The parking brake device as claimed in claim 11, wherein the support and the sliding gear have splines that collaborate with each other.

16. The parking brake device as claimed in claim 15, wherein the splines extend on an external face of the support and on an internal face of the sliding gear.

17. The parking brake device as claimed in claim 11, further comprising, between the actuator and the sliding gear, an elastically deformable part configured to allow the actuator to move when the sliding gear is immobilized by the notched wheel.

18. An electric machine comprising:
a casing;
a rotor housed in the casing;
a rotary shaft fixed to the rotor and mounted in the casing, the rotary shaft being configured to pivot via at least one rolling bearing, and the rotary shaft includes a notched wheel; and
the parking brake device as claimed in claim 11, wherein the sliding gear engages the notched wheel, in the manner of a dog clutch, when said sliding gear is in just one of the two extreme positions.

19. The electric machine as claimed in claim 18, wherein the notched wheel is shrink-fitted onto said rotary shaft.

20. A motor vehicle comprising:
a chassis;
wheels coupled to said chassis; and
the electric machine as claimed in claim 18, wherein the rotary shaft is constantly coupled to at least some of said wheels.
